(19) United States
(12) Patent Application Publication
(10) Pub. No.: US 2025/0131436 A1
(43) Pub. Date: Apr. 24, 2025

(54) SYSTEMS AND METHODS FOR ENABLING REAL-TIME GRAPH MACHINE LEARNING MODELS USING BITWISE TRANSACTION GRAPH FRAMEWORKS

(71) Applicant: JPMORGAN CHASE BANK, N.A., New York, NY (US)

(72) Inventors: Yang XIANG, Dublin, OH (US); Fang-Yu LIN, Columbus, OH (US); Erica SONG, Lewis Center, OH (US); Yibin XU, Frisco, TX (US); Josh JIANG, San Jose, CA (US)

(21) Appl. No.: 18/489,718

(22) Filed: Oct. 18, 2023

(51) Int. Cl. G06Q 20/40; G06Q 30/018

(52) U.S. Cl. CPC G06Q 20/4016; G06Q 30/018

(57) ABSTRACT

Systems and methods for enabling real-time graph machine learning models using bitwise transaction graph frameworks are disclosed. According to one embodiment, a method may include: (1) receiving, by a bitwise transaction graph computer program, a plurality of historical transactions, wherein each historical transaction comprises a customer identifier for a customer, a card number or card reference number, a merchant identifier for a merchant, a transaction authorization time, a transaction risk score, and a set of real-time fraud risk attributes; (2) converting, by the bitwise transaction graph computer program, the historical transactions to a fixed length data structure; and (3) loading, by the bitwise transaction graph computer program, the fixed length data structure onto edges of a transaction graph, wherein each vertex of the transaction graph represents one of the customers or one of the merchants.

### BACKGROUND OF THE INVENTION

### 1. Field of the Invention

Embodiments relate generally to systems and methods for enabling real-time graph machine learning models using bitwise transaction graph frameworks.

### 2. Description of the Related Art

Graphs or graph databases are often used to identify deep relationships among data. They are very useful in many machine learning and artificial intelligence (AI) applications. There are challenges in applying graph technologies to build real-time scoring models that involve a large amount of data as large volumes of data cannot be quickly loaded into a graph database server. If the data is partitioned and loaded across many graph database servers, then the real-time constraints are not met due to the heavy communication overhead across these servers.

Another challenge is data separation. A basic requirement of fraud machine learning is not using future information. If a transaction comes in at time T, then all variables built for this specific transaction should not use any information after T. Standard graph learning methods make fixed-time data separation, such as building a training graph and an evaluation graph on data of two different time periods, but do not make separations on transaction basis, and do not meet real-time modeling requirements.

### SUMMARY OF THE INVENTION

Systems and methods for enabling real-time graph machine learning models using bitwise transaction graph frameworks are disclosed. According to one embodiment, a method may include: (1) receiving, by a bitwise transaction graph computer program, a plurality of historical transactions, wherein each historical transaction may include a customer identifier for a customer, a card number or card reference number, a merchant identifier for a merchant, a transaction authorization time, a transaction risk score, and a set of real-time fraud risk attributes; (2) converting, by the bitwise transaction graph computer program, the historical transactions to a fixed length data structure; and (3) loading, by the bitwise transaction graph computer program, the fixed length data structure onto edges of a transaction graph, wherein each vertex of the transaction graph represents one of the customers or one of the merchants.

In one embodiment, the historical transactions may also include a card present or card not present indication, a merchant location, a merchant category code, an acquiring bank identification number, a transaction amount, and/or fraud label.

In one embodiment, the transaction risk score may include a Visa Advanced Authorization (VAA) risk score.

In one embodiment, a first portion of the fixed length data structure may include the transaction authorization time represented relative to a point in time. A second portion of the fixed length data structure may include a representation of the transaction risk score.

In one embodiment, the fixed length data structure may have a length of 32 bits.

According to another embodiment, a method may include: (1) receiving, by a bitwise transaction graph computer program, a current transaction from a merchant for decisioning comprising a customer identifier for a customer, a card number or a card reference number, a merchant identifier for a merchant, a transaction authorization time, a transaction risk score, and a set of real-time fraud risk attributes; (2) converting, by the bitwise transaction graph computer program, the current transaction to a fixed length data structure; (3) updating, by the bitwise transaction graph computer program, a transaction graph comprising a plurality of vertices and edges with the fixed length data structure onto an edge between a first vertex representing the customer and a second vertex representing the merchant; (4) querying, by a fraud detection computer program, the transaction graph with the card number or the card reference number, the merchant, or the transaction authorization time for the transaction; (5) receiving, by the fraud detection computer program, aggregated risk factors for the transaction from the transaction graph; and (6) decisioning, by the fraud detection computer program, the transaction based on the aggregated risk factors.

In one embodiment, each of the current transactions may further include a card present or card not present indication, a merchant location, a merchant category code, an acquiring bank identification number, a transaction amount, and/or fraud label.

In one embodiment, the aggregated risk factors may also include a darknet risk factor.

In one embodiment, the darknet risk factor may be based on a number of high risk or fraud transactions for card number or card reference numbers following transactions on a merchant device.

In one embodiment, the decisioning may also be based on business rules. The business rules are based on regulatory compliance and/or a return on investment.

According to another embodiment, a non-transitory computer readable storage medium may include instructions stored thereon, which when read and executed by one or more computer processors, cause the one or more computer processors to perform steps comprising: receiving a plurality of historical transactions, wherein each historical transaction may include a customer identifier for a customer, a card number or card reference number, a merchant identifier for a merchant, a transaction authorization time, a transaction risk score, and a set of real-time fraud risk attributes; converting the historical transactions to fixed length data structures; loading the fixed length data structures onto edges of a transaction graph, wherein each vertex of the transaction graph represents one of the customers or one of the merchants; receiving a current transaction from a merchant for decisioning comprising a current customer identifier for a current customer, a current card number or a current card reference number, a current merchant identifier for a current merchant, a current transaction authorization time, a current transaction risk score, and a current set of real-time fraud attributes; querying, by a fraud detection computer program, the transaction graph with the current card number or the current card reference number, the current merchant, or the current transaction authorization time for the current transaction; receiving, by the fraud detection computer program, aggregated risk factors for the current transaction from the transaction graph; and decisioning, by the fraud detection computer program, the current transaction based on the aggregated risk factors.

In one embodiment, the non-transitory computer readable storage medium may also include instructions stored thereon, which when read and executed by one or more computer processors, cause the one or more computer processors to perform steps comprising: converting the current transaction to the fixed length data structure; and updating the transaction graph with the current transaction fixed length data structure.

In one embodiment, each of the historical transactions may also include a card present or card not present indication, a merchant location, a merchant category code, an acquiring bank identification number, a transaction amount, and/or fraud label.

In one embodiment, the aggregated risk factors may also include a darknet risk factor. The darknet risk factor may be based on a number of high risk or fraud transactions for card number or card reference numbers following transactions on a merchant device.

In one embodiment, the decisioning may also be based on business rules. The business rules are based on regulatory compliance and/or a return on investment.

In one embodiment, the fixed length data structure may have a length of 32 bits.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 depicts a system for enabling real-time graph machine learning models using bitwise transaction graph frameworks according to an embodiment;

FIG. 2A depicts a method for creating real-time graph machine learning models according to an embodiment;

FIG. 2B depicts a method for analyzing a transaction using real-time graph machine learning models with bitwise transaction graph frameworks according to an embodiment;

FIG. 3 represents an exemplary fixed length data structure according to an embodiment; and

FIG. 4 depicts an exemplary computing system for implementing aspects of the present disclosure.

### DETAILED DESCRIPTION OF PREFERRED EMBODIMENTS

Systems and methods for enabling real-time graph machine learning models using bitwise transaction graph frameworks are disclosed. Embodiments may enable real-time graph machine learning models for credit/debit transaction fraud detection.

Embodiments may store transaction details as fixed length data entries on graph edges. For example, instead of following available graph learning approaches that build a vertex for each transaction, transactions between a customer (e.g., a credit card) and a merchant (e.g., a merchant device, such as a point of sale device) may be placed as a byte (i.e., character) sequence on the corresponding edge. The reduces storage size and improves query efficiency.

Embodiments may enable efficient bitwise computation with a relative time. In one embodiment, each transaction may be assigned a fixed length. By using a fixed length, the overhead of a transaction delimiter is eliminated. For example, the fixed length may be 4 bytes (32 bits) long, which includes the relative transaction authorization time. Other lengths may be used as is necessary and/or desired.

Embodiments may also use the relative time to fit the fixed length. For example, the time stamp may take only 24 bits of the fixed length.

Embodiments may use aggregate functions with a time cutoff to support graph machine learning. In embodiments, to meet real-time machine learning requirements, aggregate functions that aggregate the data on the graph into compact representation that may be further processed into graph variables in real-time may be used. These aggregate functions may filter out information after a given time threshold. Therefore, for a scoring request at time T, embodiments may not use any data on the graph after time T.

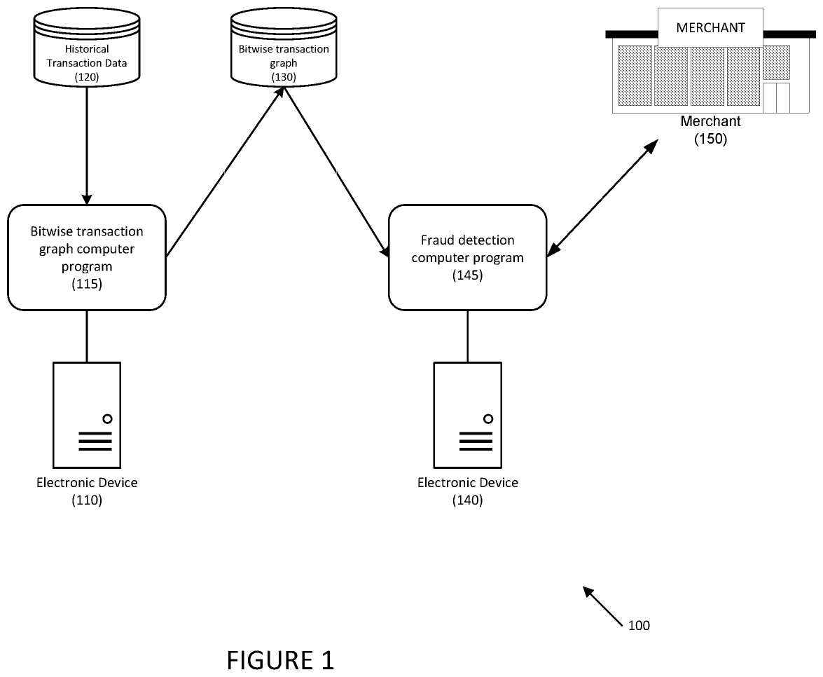

Referring to FIG. 1, a system for enabling real-time graph machine learning models using bitwise transaction graph frameworks is disclosed according to an embodiment. System 100 may include electronic device 110 that may execute bitwise transaction graph computer program 115. Electronic device may be any suitable electronic device, including servers (e.g., physical and/or cloud-based), computers (e.g., workstations, desktops, laptops, notebooks, tablets, etc.), smart devices, Internet of Things (IoT) appliances, etc.

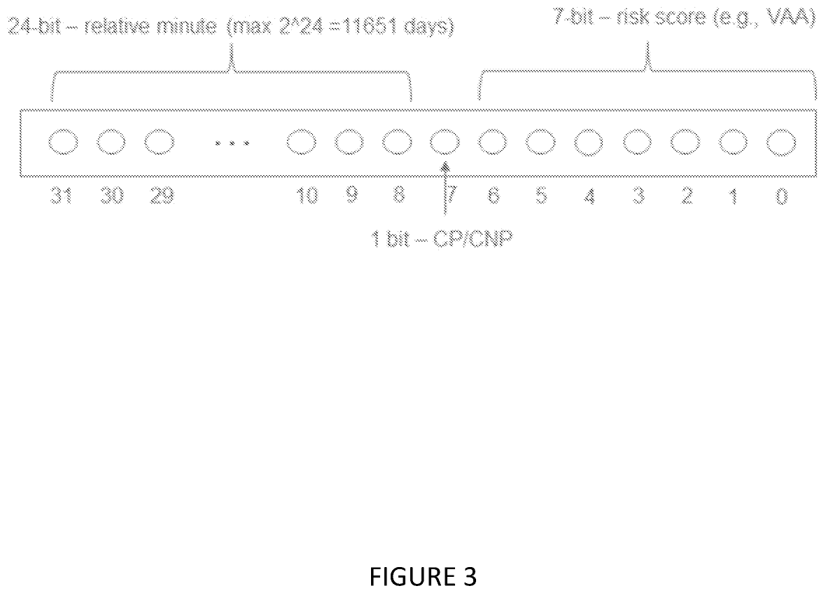

Bitwise transaction graph computer program 115 may receive historical transaction data from historical transaction data database 120. The historical transaction data may identify a merchant and a date/time for the transaction. Bitwise transaction graph computer program 115 may convert each transaction to a fixed length data structure. For example, the fixed length data structure may be 4 bytes (i.e., 32 bits); other lengths may be used as necessary and/or desired. An example structure for a fixed length data structure is provided in FIG. 3.

As illustrated in FIG. 3, 24-bits of the fixed length data structure may be used to represent the relative time for the transaction (e.g., a relative minute), one bit may be used to represent whether the transaction was a card present (CP) or card not present (CNP) transaction, and 7-bits may be used to represent a risk score for the transaction. An example of a risk score is the Visa Advanced Authorization (VAA) risk score.

Referring back to FIG. 1, the bitwise transaction graph computer program 115 may create a graph using the customer, the merchant, and the fixed length data structure for the transaction. In one embodiment, the customer and the merchant may be vertices in the graph, and the transaction may be provided as the fixed length data structure on an edge between the merchant and the customer.

For example, on the customer side, vertices may be card reference numbers (e.g., the number of a credit card). On the merchant side, the vertices may be based on a combination of two or more of a retailer identifier, a location, a merchant category codes, and an acquiring bank identification number.

Electronic device 140, which may be a fraud detection system, may execute fraud detection computer program 145. Fraud detection computer program 145 may receive a transaction from merchant 150, such as a credit card transaction, a debit card transaction, etc. Fraud detection computer program 145 may convert the transaction to a fixed length data structure having the same format as those in bitwise transaction graph 130 to update the graph, and may query bitwise transaction graph 130 with arguments extracted from the transaction. The fraud detection computer program 145 may receive information from bitwise transaction graph 130, such as aggregated features for the transaction and may further process the information for making a decision on the transaction. The features may be used for machine learning.

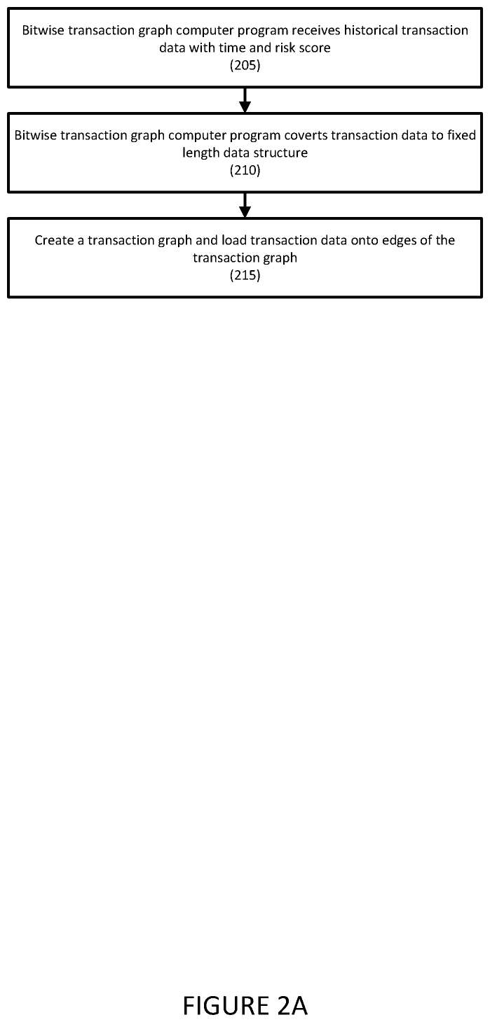

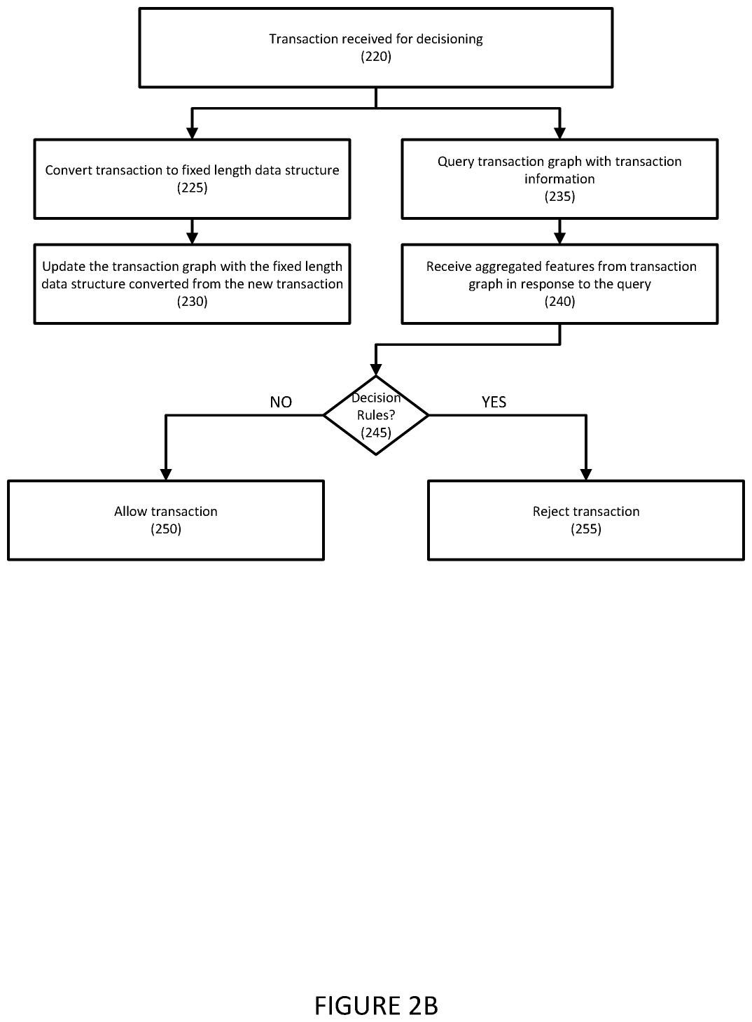

Referring to FIG. 2A, a method for creating real-time graph machine learning models is disclosed according to an embodiment.

In step 205, a bitwise transaction graph computer program may receive historical transaction data for a plurality of historical transactions. In one embodiment, the historical transaction data may include at least some of a customer identifier for a customer, a card number or card reference number, a merchant identifier for a merchant, a merchant location, a merchant category code, an acquiring bank identification number, a transaction authorization time, a transaction risk score (e.g., a VAA risk score), a transaction amount, a fraud label, a transaction amount, an account reference number, and other risk scores, and a set of real-time fraud risk attributes.

In step 210, the bitwise transaction graph computer program may convert the historical transaction data to a fixed length data structure. For example, a portion of the fixed length data structure may represent the transaction authorization time (which usually includes the date). The time may be represented relative to a point in time. Another portion may represent whether the transaction was a card present or card not present transaction, and another portion may represent the available risk score such as the VAA risk score.

In step 215, the bitwise transaction graph computer program may load the transaction data (e.g., the fixed length data structure) onto edges of a transaction graph. The edges may be between vertices representing the customer and the merchant.

Referring to FIG. 2B, a method for analyzing transactions using real-time graph machine learning models with bitwise transaction graph frameworks is disclosed according to an embodiment.

In step 220, the bitwise transaction graph computer program may receive a transaction from a merchant for decisioning. The transaction may be a credit card transaction, a debit card transaction, etc. Similar to the historical transactions, the transaction may include customer information, including a card number or a card reference number (i.e., a card number alternative), merchant information, including a merchant identifier, a location, a merchant category code, and an acquiring bank identification number, and transaction information, including a transaction authorization time, a card present or card not present indication, a transaction risk score (e.g., a VAA risk score), and a set of real-time fraud risk attributes.

The process may continue down two branches in parallel-one to update the transaction graph and a second to decision the transaction. Specifically, in step 225, the bitwise transaction graph computer program may convert the transaction to a fixed length data structure having the same format as those in the bitwise transaction graph.

In step 230, the bitwise transaction graph program may update the transaction graph with the fixed length data structure created from the new transaction. This keeps the graph up to date with current transactions.

In the other branch, in step 235, the fraud detection computer program may query the transaction graph with the transaction information. For example, the fraud detection computer program may query the transaction graph with the card number or the card reference number, the merchant, and time information extracted from the transaction to query the graph.

In step 240, the fraud detection computer program may receive aggregated feature information from the transaction graph, such as the relative risk of the current transaction with respect to the card's (i.e., the customer's) historical transactions, the fraud risk factor of the current merchant device (e.g., a point of sale device), the darknet risk factor of the current merchant device, etc. The darknet risk factor reflects the likelihood a card could be hacked at the current merchant device and sold on the darknet (or dark web). The darknet risk factor may be built for merchants on a daily basis by traversing the transaction graph and saving the results on the graph that can be retrieved in real-time.

For example, the darknet risk factor may be calculated periodically, such as once every day, and the results may be saved in the graph database. When a transaction comes in, the fraud detection computer program may query the graph for the darknet risk factor for the merchant device. In embodiments, the darknet risk factor may not be about the direct risk (i.e., a certain amount of fraud from a certain merchant device) but about the indirect risk (i.e., a certain amount of high risk or fraud transactions after cards being spent on the merchant device). Thus, embodiments may use a two-hop scan approach to determine darknet risk factor from the graph.

The fraud detection computer program may also process the information and may score the transaction using the features from transaction graph together with information from other sources to score the transaction.

In step 245, the fraud detection computer program may decision the transaction based on the information received from the bitwise transaction graph. Embodiments may apply business decision rules to make a decline/approve decision. For example, the business rules may consider fraud probability, regulatory compliance, return on investment, etc. A transaction with higher score (high risk) may not necessarily be rejected and a transaction with lower score may not necessarily be allowed.

If the transaction receives an approve decision, in step 250, the fraud detection computer program may allow the transaction.

If the transaction receives a decline decision, in step 255, the fraud detection computer program may reject the transaction.

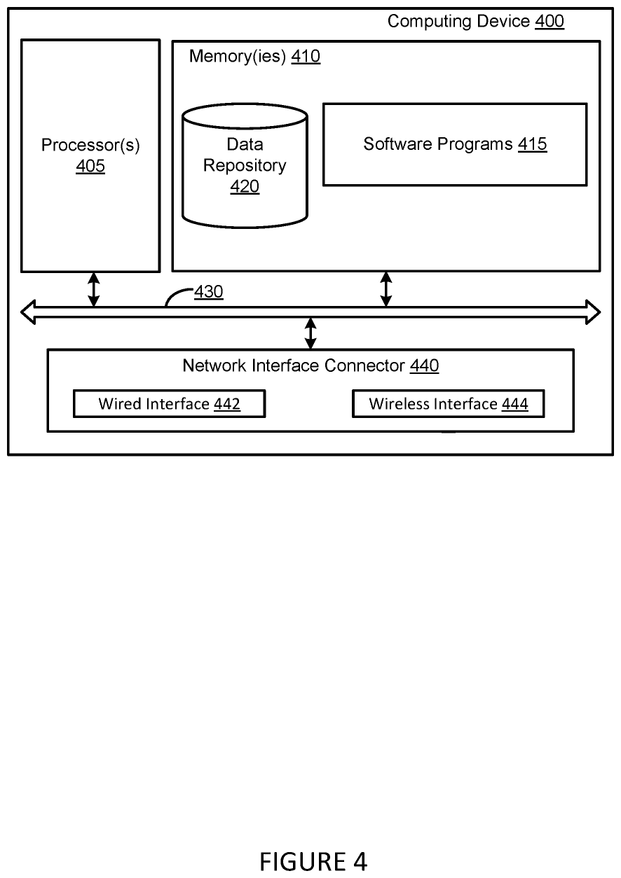

FIG. 4 depicts an exemplary computing system for implementing aspects of the present disclosure. FIG. 4 depicts exemplary computing device 400. Computing device 400 may represent the system components described herein. Computing device 400 may include processor 405 that may be coupled to memory 410. Memory 410 may include volatile memory. Processor 405 may execute computer-executable program code stored in memory 410, such as software programs 415. Software programs 415 may include one or more of the logical steps disclosed herein as a programmatic instruction, which may be executed by processor 405. Memory 410 may also include data repository 420, which may be nonvolatile memory for data persistence. Processor 405 and memory 410 may be coupled by bus 430. Bus 430 may also be coupled to one or more network interface connectors 440, such as wired network interface 442 or wireless network interface 444. Computing device 400 may also have user interface components, such as a screen for displaying graphical user interfaces and receiving input from the user, a mouse, a keyboard and/or other input/output components (not shown). The computer system does not need to be a physical machine. It can be a virtual machine, a cloud instance, a computing unit, or similar items that have the described computing functions.

Although multiple embodiments have been described, it should be recognized that these embodiments are not exclusive to each other, and that features from one embodiment may be used with others.

Hereinafter, general aspects of implementation of the systems and methods of embodiments will be described.

Embodiments of the system or portions of the system may be in the form of a “processing machine,” such as a general-purpose computer, for example. As used herein, the term “processing machine” is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular task or tasks, such as those tasks described above. Such a set of instructions for performing a particular task may be characterized as a program, software program, or simply software.

In one embodiment, the processing machine may be a specialized processor.

In one embodiment, the processing machine may be a cloud-based processing machine, a physical processing machine, or combinations thereof.

As noted above, the processing machine executes the instructions that are stored in the memory or memories to process data. This processing of data may be in response to commands by a user or users of the processing machine, in response to previous processing, in response to a request by another processing machine and/or any other input, for example.

As noted above, the processing machine used to implement embodiments may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA (Field-Programmable Gate Array), PLD (Programmable Logic Device), PLA (Programmable Logic Array), or PAL (Programmable Array Logic), or any other device or arrangement of devices that is capable of implementing the steps of the processes disclosed herein.

The processing machine used to implement embodiments may utilize a suitable operating system.

It is appreciated that in order to practice the method of the embodiments as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above, in accordance with a further embodiment, may be performed by a single component. Further, the processing performed by one distinct component as described above may be performed by two distinct components.

In a similar manner, the memory storage performed by two distinct memory portions as described above, in accordance with a further embodiment, may be performed by a single memory portion. Further, the memory storage performed by one distinct memory portion as described above may be performed by two memory portions.

Further, various technologies may be used to provide communication between the various processors and/or memories, as well as to allow the processors and/or the memories to communicate with any other entity; i.e., so as to obtain further instructions or to access and use remote memory stores, for example. Such technologies used to provide such communication might include a network, the Internet, Intranet, Extranet, a LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of embodiments. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of embodiments may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments. Also, the instructions and/or data used in the practice of embodiments may utilize any compression or encryption technique or algorithm, as may be desired. An encryption module might be used to encrypt data. Further, files or other data may be decrypted using a suitable decryption module, for example.

As described above, the embodiments may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in embodiments may take on any of a variety of physical forms or transmissions, for example. Illustratively, the medium may be in the form of a compact disc, a DVD, an integrated circuit, a hard disk, a floppy disk, an optical disc, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by the processors.

Further, the memory or memories used in the processing machine that implements embodiments may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the systems and methods, a variety of “user interfaces” may be utilized to allow a user to interface with the processing machine or machines that are used to implement embodiments. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method, it is not necessary that a human user actually interact with a user interface used by the processing machine. Rather, it is also contemplated that the user interface might interact, i.e., convey and receive information, with another processing machine, rather than a human user. Accordingly, the other processing machine might be characterized as a user. Further, it is contemplated that a user interface utilized in the system and method may interact partially with another processing machine or processing machines, while also interacting partially with a human user.

It will be readily understood by those persons skilled in the art that embodiments are susceptible to broad utility and application. Many embodiments and adaptations of the present invention other than those herein described, as well as many variations, modifications and equivalent arrangements, will be apparent from or reasonably suggested by the foregoing description thereof, without departing from the substance or scope.

Accordingly, while the embodiments of the present invention have been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications or equivalent arrangements.

What is claimed is:

1. A method, comprising:
receiving, by a bitwise transaction graph computer program, a plurality of historical transactions, wherein each historical transaction comprises a customer identifier for a customer, a card number or card reference number, a merchant identifier for a merchant, a transaction authorization time, a transaction risk score, and a set of real-time fraud risk attributes;
converting, by the bitwise transaction graph computer program, the historical transactions to a fixed length data structure; and
loading, by the bitwise transaction graph computer program, the fixed length data structure onto edges of a transaction graph, wherein each vertex of the transaction graph represents one of the customers or one of the merchants.

2. The method of claim 1, wherein each of the historical transactions further comprises a card present or card not present indication, a merchant location, a merchant category code, an acquiring bank identification number, a transaction amount, and/or fraud label.

3. The method of claim 1, wherein the transaction risk score comprises a Visa Advanced Authorization (VAA) risk score.

4. The method of claim 1, wherein a first portion of the fixed length data structure comprises the transaction authorization time represented relative to a point in time.

5. The method of claim 4, wherein a second portion of the fixed length data structure comprises a representation of the transaction risk score.

6. The method of claim 1, wherein the fixed length data structure has a length of 32 bits.

7. A method, comprising:
receiving, by a bitwise transaction graph computer program, a current transaction from a merchant for decisioning comprising a customer identifier for a customer, a card number or a card reference number, a merchant identifier for a merchant, a transaction authorization time, a transaction risk score, and a set of real-time fraud risk attributes;
converting, by the bitwise transaction graph computer program, the current transaction to a fixed length data structure;
updating, by the bitwise transaction graph computer program, a transaction graph comprising a plurality of vertices and edges with the fixed length data structure onto an edge between a first vertex representing the customer and a second vertex representing the merchant;
querying, by a fraud detection computer program, the transaction graph with the card number or the card reference number, the merchant, or the transaction authorization time for the transaction;
receiving, by the fraud detection computer program, aggregated risk factors for the transaction from the transaction graph; and
decisioning, by the fraud detection computer program, the transaction based on the aggregated risk factors.

8. The method of claim 7, wherein each of the current transactions further comprises a card present or card not present indication, a merchant location, a merchant category code, an acquiring bank identification number, a transaction amount, and/or fraud label.

9. The method of claim 7, wherein the aggregated risk factors further comprise a darknet risk factor.

10. The method of claim 9, wherein the darknet risk factor is based on a number of high risk or fraud transactions for card number or card reference numbers following transactions on a merchant device.

11. The method of claim 7, wherein the decisioning is further based on business rules.

12. The method of claim 11, wherein the business rules are based on regulatory compliance and/or a return on investment.

13. A non-transitory computer readable storage medium, including instructions stored thereon, which when read and executed by one or more computer processors, cause the one or more computer processors to perform steps comprising:
receiving a plurality of historical transactions, wherein each historical transaction comprises a customer identifier for a customer, a card number or card reference number, a merchant identifier for a merchant, a transaction authorization time, a transaction risk score, and a set of real-time fraud risk attributes;
converting the historical transactions to fixed length data structures;
loading the fixed length data structures onto edges of a transaction graph, wherein each vertex of the transaction graph represents one of the customers or one of the merchants;
receiving a current transaction from a merchant for decisioning comprising a current customer identifier for a current customer, a current card number or a current card reference number, a current merchant identifier for a current merchant, a current transaction authorization time, a current transaction risk score, and current set of real-time fraud risk attributes;
querying, by a fraud detection computer program, the transaction graph with the current card number or the current card reference number, the current merchant, or the current transaction authorization time for the current transaction;
receiving, by the fraud detection computer program, aggregated risk factors for the current transaction from the transaction graph; and
decisioning, by the fraud detection computer program, the current transaction based on the aggregated risk factors.

14. The non-transitory computer readable storage medium of claim 13, further including instructions stored thereon, which when read and executed by one or more computer processors, cause the one or more computer processors to perform steps comprising:
converting the current transaction to the fixed length data structure; and
updating the transaction graph with the current transaction fixed length data structure.

15. The non-transitory computer readable storage medium of claim 13, wherein each of the historical transactions further comprises a card present or card not present indication, a merchant location, a merchant category code, an acquiring bank identification number, a transaction amount, and/or fraud label.

16. The non-transitory computer readable storage medium of claim 13, wherein the aggregated risk factors further comprise a darknet risk factor.

17. The non-transitory computer readable storage medium of claim 16, wherein the darknet risk factor is based on a number of high risk or fraud transactions for card number or card reference numbers following transactions on a merchant device.

18. The non-transitory computer readable storage medium of claim 13, wherein the decisioning is further based on business rules.

19. The non-transitory computer readable storage medium of claim 18, wherein the business rules are based on regulatory compliance and/or a return on investment.

20. The non-transitory computer readable storage medium of claim 13, wherein the fixed length data structure has a length of 32 bits.
